(19) United States
(12) Patent Application Publication
(10) Pub. No.: US 2006/0117873 A1
(43) Pub. Date: Jun. 8, 2006

(54) Safety shower testing apparatus

(75) Inventors: Sandra Janeellen Rosar, Wilmington, DE (US); Carlton J. Twilley JR., Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(73) Assignee: E.1 DU Pont de Nemours and Company

(21) Appl. No.: 10/426,391

(22) Filed: Apr. 30, 2003

Related U.S. Application Data
(60) Provisional application No. 60/449,997, filed on Feb. 26, 2003.
(60) Provisional application No. 60/445,065, filed on Feb. 5, 2003.

(51) Int. Cl. G01N 19/00

(52) U.S. Cl. 73/865.9

(57) ABSTRACT

This invention relates to an apparatus for testing a safety shower that is self-contained and provides a safe, efficient and convenient method for carrying out safety shower testing.

### FIELD OF THE INVENTION

This invention relates to a self-contained apparatus for testing a safety shower and a method for testing a safety shower using this apparatus.

### BACKGROUND OF THE INVENTION

Safety showers are used to provide first aid treatment in research laboratories, industrial plants and other environments. When a person may be exposed to injurious corrosive, toxic or flammable material, it is mandatory to provide suitable facilities within the work area for quick drenching of the body (OSHA 1910.151). A person exposed to such a material is quickly positioned under a safety shower and the shower activated to provide a heavy steady stream of water to wash away the corrosive, toxic or flammable material. Contaminated clothing is removed as quickly as possible while showering.

It is clearly very important to always have the safety shower in proper working condition in order to be prepared for any emergency. As a result, safety showers are typically tested on some regular basis, e.g., daily or weekly, to insure that there is adequate flow of clean water. A typical test lasts a minimum of 15 seconds. The safety shower is typically tested while a bucket is held under the showerhead to catch the water. Alternatively, a chute may be used to catch the water and direct it into the floor drain that is usually placed under a safety shower. In either case, it is likely that the floor or the persons conducting the test will be splashed with water either during the test or in removing the bucket or chute following the test. A wet floor provides a safety hazard that must be addressed.

An object of the present invention is to provide an apparatus to greatly facilitate the testing of a safety shower.

### SUMMARY OF THE INVENTION

This invention provides an apparatus for testing a safety shower, comprising:
a) a container capable of holding water and of sufficient size to contain the water released from a safety shower during the testing of the safety shower;
b) a vertical rigid extensible pole attached to the container;
c) an annulus of a rigid material attached to the upper end of the pole, wherein the diameter of the annulus is greater than the diameter of the showerhead of the safety shower to be tested so that the showerhead readily passes through the annulus; and
d) an elongated flexible tubular chute of a waterproof material, wherein the upper end of the chute is attached to the annulus and the lower end of the chute is positioned within the container.

Preferably, the apparatus further comprises means to move the apparatus from one location to another. This means can be comprised of casters or wheels attached to the container or in the form of a dolly that supports the container. The dolly is preferably attached to the container. Preferably, the apparatus further comprises means to remove the water from the container. This means can be comprised of an electrically-powered water pump and a sufficient length of waterproof tubing to enable the water to be pumped from the container to a sink or drain. Preferably, the electrically-powered water pump is a submersible pump.

The apparatus of the invention is self-contained and provides a safe, efficient and convenient method for carrying out safety shower testing.

A method for testing a safety shower using a preferred embodiment of the apparatus of the invention that further comprises means to move the apparatus from one location to another and means to remove the water from the container comprises:
a) positioning the apparatus under the safety shower to be tested;
b) adjusting the extensible pole so that the bottom of the showerhead of the safety shower is encompassed by the chute;
c) activating the safety shower and allowing the water to flow from the safety shower for the designated time period of the test;
d) de-activating the safety shower upon completion of the designated time period of the test and lowering the extensible pole so that the showerhead of the safety shower is no longer encompassed by the chute;
e) moving the apparatus containing the water from the safety shower to a sink or a drain;
f) activating the means to remove water from the container and continuing until the water is removed from the container; and
g) de-activating the means to remove water from the container.

### BRIEF DESCRIPTION OF THE DRAWINGS

FIG. 1 is a schematic of one embodiment of the safety shower testing apparatus.

### DETAILED DESCRIPTION OF THE PREFERRED EMBODIMENTS

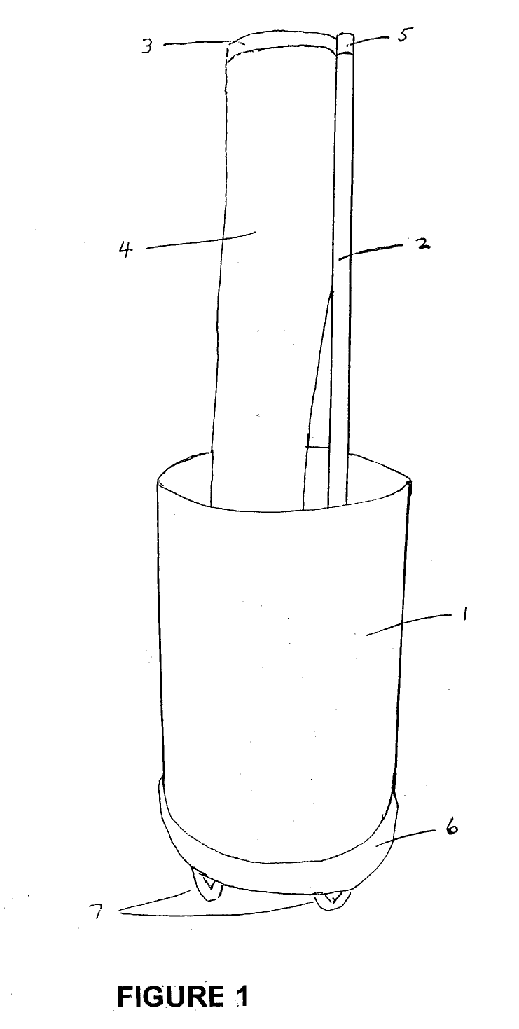

The present invention provides an apparatus for carrying out safety shower testing. The invention may be described and understood by considering the schematic of one embodiment of the safety shower testing apparatus as shown in FIG. 1. The apparatus is comprised of a container 1 capable of holding water and of sufficient size to contain the water released from the safety shower during the testing of the safety shower. The shape of this container is not critical. It can be in the form of a bucket or drum. The container must be made of a material that provides containment of water. Plastic is a preferable material from the point of view of expense and weight. However, a metal, ceramic or wood container can also be used. The required minimum size of the container can be estimated by knowing the flow rate from the safety shower to be tested and the time period of the test. To avoid splashing of water out of the container either during the test or while the container is being moved to a sink or drain, it is advisable to make the size of the container at least 1.5 times that of the required minimum size. If the apparatus is to be used in a location with several safety showers, it is especially convenient to test the several showers sequentially without emptying the container and therefore necessary to make the container sufficiently large so as to hold the water released during the tests of all the several safety showers and to still provide an allowance for a fill level above which the container is not filled with water. In these instances, a container, e.g., a plastic drum, with a capacity of 30 gallons or more is especially useful.

The apparatus further comprises a vertical rigid extensible pole 2 attached to the container. Attached to the upper end of the pole is an annulus 3 of a rigid material. The apparatus further comprises an elongated flexible tubular chute 4 of a waterproof material with the upper end of the chute attached to the annulus and the lower end of the chute positioned within the container. The purpose of the extensible pole 2 is to provide a support for the annulus to which the chute is attached and to provide means to raise and lower the chute. The extensible pole can be a simple two piece pole with one tube contained within a second and the inner tube able to be moved to and fixed into various positions much like a painter's extension pole. The pole can be one that is moveable and adjustable by hand or one that is electrically powered. The pole must be made of a rigid material and of sufficient strength to support the chute with the water from the safety shower running through it.

The annulus 3 is attached to the upper end of the extensible pole by a clamp or bracket 5 as shown in FIG. 1. The annulus must be of sufficient strength to support the chute with the water from the safety shower running through it. The diameter of the annulus is greater than the diameter of the showerhead of the safety shower to be tested so that, as the extensible pole is extended upward, the showerhead readily passes through the annulus. This is necessary so that the showerhead is encompassed by the chute attached to the annulus and the water from the safety shower is thereby confined within the chute. In practice the chute may be wrapped around the annulus to provide a more secure and waterproof attachment and in this instance the annulus would not be visible. The chute 4 is elongated, flexible and tubular and any waterproof material that will satisfy these criteria can be used to form the chute. The chute must be sufficiently long so that the lower end of the chute can be positioned within the container when the upper end of the chute has been raised to encompass the showerhead.

Preferably, the apparatus further comprises means to move the apparatus from one location to another. This means can be comprised of casters or wheels directly attached to the container. Alternatively, the means to move the apparatus from one location to another can be in the form of a dolly, i.e., a platform on a roller or wheels or casters used for transporting an object. The dolly supports the container and preferably is attached to the container. Such a dolly 6 with casters 7 is indicated in the embodiment shown in FIG. 1.

Preferably, the apparatus further comprises means to remove the water from the container. This means can be comprised of an electrically-powered water pump and a sufficient length of waterproof tubing to enable the water to be pumped from the container to a sink or drain. Preferably, the electrically-powered water pump is a submersible pump. Alternatively, this means is comprised of a valve at the bottom of said container to enable said water to emptied into a drain. In this instance a length of waterproof tubing can be attached to the valve to facilitate directing the water into the drain.

The preferred embodiment of the apparatus of the invention comprises both means to move the apparatus from one location to another and means to remove the water from the container. The first step in the method for testing a safety shower using this preferred embodiment of the apparatus of the invention is the positioning of the apparatus under the safety shower to be tested. The extensible pole is then adjusted so that the bottom of the showerhead of the safety shower is encompassed by the chute. The safety shower is activated the safety shower and the water is allowed to flow from the safety shower for the designated time period of the test. Upon completion of the designated time period of the test, the safety shower is de-activated and the extensible pole is lowered so that the showerhead of the safety shower is no longer encompassed by the chute. If another safety shower in the vicinity is to be tested, the apparatus containing the water is then moved from the safety shower already tested to the next safety shower to be tested and the above steps repeated. When testing is completed, the apparatus is moved to a sink or a drain so that the water can be emptied from the container. The means to remove water from the container is activated and continued until the water is removed from the container. When the means to remove water from the container is comprised of an electrically-powered water pump and a sufficient length of waterproof tubing to enable the water to be pumped from the container to the sink or drain, the activation step would comprise holding the output end of the waterproof tubing in the sink or over the drain and then activating the electrically-powered water pump. When the water has been removed, the means to remove water from the container is de-activated.

What is claimed is:

1. An apparatus for testing a safety shower, comprising:
a) a container capable of holding water and of sufficient size to contain the water released from said safety shower during the testing of said safety shower;
b) a vertical rigid extensible pole attached to said container;
c) an annulus of a rigid material attached to the upper end of said extensible pole, wherein the diameter of said annulus is greater than the diameter of the showerhead of said safety shower to be tested so that said showerhead readily passes through said annulus; and
d) an elongated flexible tubular chute of a waterproof material, wherein the upper end of said chute is attached to said annulus and the lower end of said chute is positioned within said container.

2. The apparatus of claim 1, further comprising means to move said apparatus from one location to another.

3. The apparatus of claim 2, wherein said means is comprised of casters or wheels attached to said container.

4. The apparatus of claim 2, wherein said means is comprised of a dolly that supports said container.

5. The apparatus of claim 4, wherein said dolly is attached to said container.

6. The apparatus of any of claims 1-5, further comprising means to remove said water from said container.

7. The apparatus of claim 6, wherein said means is comprised of an electrically-powered water pump and a sufficient length of waterproof tubing to enable said water to be pumped from said container to a sink or drain.

8. The apparatus of claim 7, wherein said electrically-powered water pump is a submersible pump.

9. The apparatus of claim 6, wherein said means is comprised of a valve at the bottom of said container to enable said water to be emptied into a drain.

10. An apparatus for testing at least two safety showers, comprising:
a) a container capable of holding water and of sufficient size to contain the water released from all of said at least two safety showers during the testing of said at least two safety showers;
b) a vertical rigid extensible pole attached to said container;
c) an annulus of a rigid material attached to the upper end of said extensible pole, wherein the diameter of said annulus is greater than the diameter of each of the showerheads of said at least two safety showers to be tested so that each said showerhead readily passes through said annulus;
d) an elongated flexible tubular chute of a waterproof material, wherein the upper end of said chute is attached to said annulus and the lower end of said chute is positioned within said container;
e) means to move said apparatus from one location to another; and
f) means to remove said water from said container.

11. The apparatus of claim 10, wherein said means to move said apparatus from one location to another is comprised of casters or wheels attached to said container.

12. The apparatus of claim 10, wherein said means to move said apparatus from one location to another is comprised of a dolly that supports said container.

13. The apparatus of claim 12, wherein said dolly is attached to said container.

14. The apparatus of any of claims 10-13, wherein said means to remove said water from said container is comprised of an electrically-powered water pump and a sufficient length of waterproof tubing to enable said water to be pumped from said container to a sink or drain.

15. The apparatus of claim 14, wherein said electrically-powered water pump is a submersible pump.

16. The apparatus any of claims 10-13, wherein said means is comprised of a valve at the bottom of said container to enable said water to be emptied into a drain.

17. A method for testing a safety shower using an apparatus comprising a container capable of holding water, a vertical rigid extensible pole attached to said container, an annulus of a rigid material attached to the upper end of said extensible pole, an elongated flexible tubular chute of a waterproof material, wherein the upper end of said chute is attached to said annulus and the lower end of said chute is positioned within said container, means to move said apparatus from one location to another, and means to remove said water from said container, said method comprising:
a) positioning the apparatus under said safety shower to be tested;
b) adjusting said extensible pole so that the bottom of the showerhead of said safety shower is encompassed by said chute;
c) activating said safety shower and allowing the water to flow from said safety shower for the designated time period of the test;
d) de-activating said safety shower upon completion of said designated time period of said test and lowering said extensible pole so that the showerhead of said safety shower is no longer encompassed by said chute;
e) moving said apparatus containing said water from said safety shower to a sink or a drain;
f) activating said means to remove said water from said container and continuing until said water is removed from said container; and
g) de-activating said means to remove water from said container.

18. The method of claim 17, wherein said means to move said apparatus is comprised of a dolly that supports said container.

19. The method of claim 18, wherein said dolly is attached to said container.

20. The method of claim 17, wherein said means to move said apparatus from one location to another is comprised of casters or wheels attached to said container.

21. The method of any of claims 17-20, wherein said means to remove said water from said container is comprised of an electrically-powered water pump and a sufficient length of waterproof tubing to enable said water to be pumped from said container to a sink or drain.

22. The method of any of claims 17-20, wherein said means to remove said water from said container is comprised of a valve at the bottom of said container to enable said water to be emptied into a drain.

23. A method for testing at least two safety showers using an apparatus comprising a container capable of holding water, a vertical rigid extensible pole attached to said container, an annulus of a rigid material attached to the upper end of said extensible pole, an elongated flexible tubular chute of a waterproof material, wherein the upper end of said chute is attached to said annulus and the lower end of said chute is positioned within said container, means to move said apparatus from one location to another, and means to remove said water from said container, said method comprising:
a) positioning the apparatus under the first of said at least two safety showers to be tested;
b) adjusting said extensible pole so that the bottom of the showerhead of said first safety shower is encompassed by said chute;
c) activating said first safety shower and allowing the water to flow from said first safety shower for the designated time period of the test;
d) de-activating said first safety shower upon completion of said designated time period of said test and lowering said extensible pole so that the showerhead of said first safety shower is no longer encompassed by said chute;
e) moving said apparatus containing said water from said first safety shower to each of the other said at least two safety showers to be tested in turn and repeating steps a-d) at each of the other said at least two safety showers;
f) moving said apparatus containing the water from the last of the said at least two safety showers to be tested to a sink or a drain;
g) activating said means to remove said water from said container and continuing until said water is removed from said container; and
h) de-activating said means to remove water from said container.

25. The method of claim 23, wherein said means to move said apparatus is comprised of a dolly that supports said container.

25. The method of claim 24, wherein said dolly is attached to said container.

26. The method of claim 23, wherein said means to move said apparatus from one location to another is comprised of casters or wheels attached to said container.

27. The method of any of claims 23-26, wherein said means to remove said water from said container is comprised of an electrically-powered water pump and a sufficient length of waterproof tubing to enable said water to be pumped from said container to a sink or drain.

28. The method of any of claims 23-26, wherein said means to remove said water from said container is comprised of a valve at the bottom of said container to enable said water to be emptied into a drain.
